(19) United States
(12) Patent Application Publication
(10) Pub. No.: US 2018/0001490 A1
(43) Pub. Date: Jan. 4, 2018

(54) PRECISION KNIFE WITH RING HOOK

(71) Applicant: SLICE, INC., San Jose, CA (US)

(72) Inventors: Thomas John Scimone, San Jose, CA (US); Scot Herbst, Santa Cruz, CA (US)

(21) Appl. No.: 15/377,052

(22) Filed: Dec. 13, 2016

Related U.S. Application Data
(63) Continuation-in-part of application No. 15/200,101, filed on Jul. 1, 2016.

(51) Int. Cl. B26B 5/00; B26B 29/02; B25G 1/10

(52) U.S. Cl. CPC B26B 5/00; B25G 1/102; B26B 29/025

(57) ABSTRACT

A ring handle for a craft knife that is configured to securely hold a cutting blade by forming a friction fit with the cutting blade and without engaging with a hole or notch in the cutting blade. The craft knife handle includes a blade slot recess that is formed with a ridge or tapered section that is adapted to abut with the edges of the cutting blade that are inserted into the blade slot. The craft knife handle also includes a collar that engages with the handle body of the craft knife handle to secure the cutting blade within the blade slot. The craft knife handle may also incorporate a no-roll design with at least one facet of the handle being flat.

### FIELD OF THE INVENTION

The present invention generally relates to craft knives. Specifically, embodiments of the present invention relate to a knife handle that is configured to securely hold a cutting blade without the need to engage with a hole or notch in the cutting blade. Embodiments of the knife handle further include a no-roll design and a ring handle.

### CROSS REFERENCE TO RELATED APPLICATION

This application is a continuation-in-part of U.S. Non-Provisional Utility patent application Ser. No. 15/200,101, filed on Jul. 1, 2016 and entitled “CRAFT KNIFE HANDLE, whereby the entire disclosure is incorporated herein by reference.

### BACKGROUND

A craft knife is a cutting tool that is commonly used in a variety of applications. Standard craft knives handles are generally configured to hold cutting blades by engaging with holes or notches formed in the cutting blade. In certain circumstances, it may not be possible to manufacture a cutting blade that has the appropriate holes or notches due to design limitations of particular materials. As an illustrative example, forming a hole or notch in a ceramic cutting blade compromises the strength of the ceramic cutting blade and increases the manufacturing costs. If the craft knife handle does not engage with a notch or hole in the cutting blade, then the cutting blade may not be secured sufficiently so as to prevent unwanted movement or shifting of the cutting blade within the craft knife handle. This issue can be further exacerbated by manufacturing tolerances in both the cutting blade and craft knife handle that cause a looser than intended fit between the cutting blade and the craft knife handle.

Therefore, there is a need in the art for a craft knife handle that can securely hold a cutting blade without the need to engage with a hole or notch formed in the cutting blade, while also being able to account for manufacturing tolerances of cutting blades. These and other features and advantages of the present invention will be explained and will become obvious to one skilled in the art through the summary of the invention that follows.

### SUMMARY OF THE INVENTION

Accordingly, it is an aspect of the present invention to provide a craft knife handle that can securely hold a cutting blade without the need to engage with a hole or notch in the cutting blade. In particular, it is an object of the present invention to provide a craft knife handle that can securely hold a cutting blade that is formed without any engagement holes or notches, including ceramic cutting blades. Furthermore, it is an aspect of the present invention to provide a craft knife handle with a well-balanced and ergonomic feel, including a weighted design for balance and stability, as well as an anti-slip control grip.

According to an embodiment of the present invention, a craft knife handle comprising: a handle body formed as a single continuous unit and comprising a front segment formed with a blade slot, a middle segment formed with a collar engagement means, and a rear segment formed with at least one flat facet, wherein the blade slot extends through the front segment and terminates as a blade slot recess that is formed as an indentation in the middle segment that tapers down in height as the blade slot recess extends into the middle segment, and a handle collar formed as a tube with a handle body engagement means on an interior portion of the handle collar.

According to an embodiment of the present invention, the craft knife handle further comprises a safety cap.

According to an embodiment of the present invention, the safety cap is formed with at least one flat facet, each of which corresponds to one of the flat facets on the rear segment.

According to an embodiment of the present invention, the craft knife handle further comprises a cutting blade.

According to an embodiment of the present invention, the handle body is substantially cylindrical in shape.

According to an embodiment of the present invention, the blade slot is formed entirely through the front segment and passes through the longitudinal axis of the front segment.

According to an embodiment of the present invention, the collar engagement means is a threaded portion formed on the middle segment.

According to an embodiment of the present invention, the collar engagement means defines the front boundary of the middle segment.

According to an embodiment of the present invention, the blade slot recess begins extending into the middle segment at the front boundary.

According to an embodiment of the present invention, the blade slot begins as a V-shaped notch in a front tip of the front segment.

According to an embodiment of the present invention, the blade slot recess is adapted to abut with one or more rear edges of a cutting blade to prevent vertical movement of the cutting blade within the blade slot.

According to an embodiment of the present invention, the front tip of the interior portion of the handle collar has sloped segment connecting between a first interior diameter segment and a second interior diameter segment that has a larger diameter than the first interior diameter segment.

According to an embodiment of the present invention, the handle body engagement means is a threaded portion formed on an interior portion of the handle collar.

According to an embodiment of the present invention, a craft knife handle comprising: a handle body formed as a single continuous unit and comprising a front segment formed with a blade slot, a middle segment formed with a collar engagement means, and a rear segment formed with at least one flat facet, wherein the blade slot extends through the front segment and terminates as a blade slot recess that is formed as an indentation in the middle segment that tapers down in height as the blade slot recess extends into the middle segment, and a handle collar formed as a tube with a handle body engagement means on an interior portion of the handle collar, wherein a front tip of the interior portion of the handle collar has sloped segment connecting between a first interior diameter segment and a second interior diameter segment.

According to an embodiment of the present invention, the second interior segment of the handle collar has a larger diameter than the first interior diameter segment of the handle collar.

According to an embodiment of the present invention, the collar engagement means and the handle body engagements means are corresponding threaded portions that enable the handle collar to reversibly tighten around the handle body to secure a cutting blade within the blade slot.

According to an embodiment of the present invention, the sloped segment is configured to apply pressure to the front segment of the handle body to squeeze the cutting blade within the blade slot.

According to an embodiment of the present invention, a craft knife handle comprising: a handle body formed as a single continuous unit and comprising a front segment formed with a blade slot, a middle segment formed with a collar engagement means, and a rear segment formed with at least one flat facet, wherein the blade slot extends through the front segment and terminates as a blade slot recess that is formed as an indentation in the middle segment that tapers down in height as the blade slot recess extends into the middle segment, a handle collar formed as a tube with a handle body engagement means on an interior portion of the handle collar, a safety cap that is configured to slide over and engage with either end of the handle body via a friction fit, and a cutting blade that is inserted into the blade slot and secured in the blade slot by the handle collar.

According to an embodiment of the present invention, the blade slot recess is configured to receive the cutting blade to prevent vertical movement of the cutting blade within the blade slot.

According to an embodiment of the present invention, the flat facet of the rear segment of the body is configured to prevent unwanted rolling of the craft knife handle.

According to an alternate embodiment of the present invention, a ring knife comprising of a cutting blade, a handle collar, and a handle body, wherein said handle body comprises of a front segment formed with a blade slot, a middle segment formed with a collar engagement means, and a rear segment formed as a single continuous unit extending into a closed ring, wherein said cutting blade slot extends through said front segment and terminates as a blade slot recess that is formed as an indentation in said middle segment that tapers down in height as said blade slot recess extends into said middle segment; and a handle collar formed as a tube with a handle body engagement means on an interior portion of said handle collar.

According to an alternate embodiment of the present invention, the rear end of a ring knife is arched.

According to an alternate embodiment of the present invention, the rear end of a ring knife is arched upwards.

According to an alternate embodiment of the present invention, the ring knife the craft knife handle further comprises a safety cap.

According to an alternate embodiment of the present invention, the safety cap is formed with at least one flat facet, each of which corresponds to one of the flat facets on the rear segment.

According to an alternate embodiment of the present invention, the craft knife handle further comprises a cutting blade.

According to an alternate embodiment of the present invention, the blade slot is formed entirely through the front segment and passes through the longitudinal axis of the front segment.

According to an alternate embodiment of the present invention, the collar engagement means is a threaded portion formed on the middle segment.

According to an alternate embodiment of the present invention, the collar engagement means defines the front boundary of the middle segment.

According to an alternate embodiment of the present invention, the blade slot recess begins extending into the middle segment at the front boundary.

According to an alternate embodiment of the present invention, the blade slot begins as a V-shaped notch in a front tip of the front segment.

According to an e alternate embodiment of the present invention, the blade slot recess is adapted to abut with one or more rear edges of a cutting blade to prevent vertical movement of the cutting blade within the blade slot.

According to an alternate embodiment of the present invention, the front tip of the interior portion of the handle collar has sloped segment connecting between a first interior diameter segment and a second interior diameter segment that has a larger diameter than the first interior diameter segment.

According to an alternate embodiment of the present invention, the handle body engagement means is a threaded portion formed on an interior

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is an exploded view of a craft knife handle in accordance with an embodiment of the present invention;

FIG. 2 is a side view of a craft knife handle in accordance with an embodiment of the present invention;

FIG. 3 is a top view of a craft knife handle in accordance with an embodiment of the present invention;

FIG. 4 is a bottom view of a craft knife handle in accordance with an embodiment of the present invention;

FIG. 5 is a cross-section of a craft knife handle in accordance with an embodiment of the present invention;

FIG. 6 is a front view of a craft knife handle in accordance with an embodiment of the present invention;

FIG. 7 is a rear view of a craft knife handle in accordance with an embodiment of the present invention;

FIG. 8 is a detailed cross-section of the connection between the handle collar and the handle body of a craft knife handle in accordance with an embodiment of the present invention;

FIG. 9 is a top view outlining a blade slot recess formed in the front tip a craft knife handle in accordance with an embodiment of the present invention;

FIG. 10 is a side view outlining a blade slot recess formed in the front tip a craft knife handle in accordance with an embodiment of the present invention; and

FIG. 11 is a cross section of a handle collar of a craft knife handle in accordance with an embodiment of the present invention.

FIG. 12 is a front view of a front view of a craft knife in accordance with an alternate embodiment of the present invention.

### DETAILED SPECIFICATION

The present invention generally relates to craft knives. Specifically, embodiments of the present invention relate to a craft knife handle that is configured to securely hold a cutting blade without the need to engage with a hole or notch in the cutting blade. Embodiments of the craft knife handle further include a no-roll design and safety cap.

According to an embodiment of the present invention, the craft knife handle described herein primarily comprises a handle body and a handle collar. In some embodiments, the craft knife handle further comprises a cutting blade and a safety cap. Certain embodiments of the craft knife handle may include fewer components or additional components depending on the utilization and purpose for the craft knife handle. Embodiments of the craft knife handle may be formed in a variety of designs and optionally configured with any combination of components with departing from the spirit and scope of the invention.

According to an embodiment of the present invention, the handle body of the craft knife handle is a single, continuously formed unit. In a preferred embodiment, the handle body may be primarily cylindrical in shape and comprises a front segment configured to receive cutting blade, a middle segment configured to engage with the handle collar, and a rear segment formed with a no-roll flat facet. In the preferred embodiment, the front segment is formed with a blade slot that begins as a V-shaped notch in the front tip of the handle body and extends as a slot along the length the front segment. The middle segment includes a threaded portion that defines the front boundary of the middle segment is adapted to engage with a corresponding threaded portion on the inside of the handle collar. The rear segment is configured with at least one flat facet that prevents the craft knife handle from rolling. In the preferred embodiment, the front segment has a smaller diameter relative to the middle segment and the middle segment has a smaller diameter relative to the rear segment. One of ordinary skill in the art would appreciate that there are many suitable designs for a craft knife handle, and embodiments of the present invention are contemplated to take advantage of any such design.

According to an embodiment of the present invention, a blade slot is formed in the front segment of the craft knife handle. In a preferred embodiment, the blade slot is an opening formed continuously from the top to the bottom of the front segment and passes through the longitudinal axis of the front segment. The blade slot begins as a V-shaped notch at the tip of the front segment, continues through the front segment and terminates at a blade slot recess that is formed in the front of the middle segment of the craft knife handle. In the preferred embodiment, the width and height of the blade slot are sufficient to the accommodate the thickness and height of the desired cutting blade, while the length of the blade slot is sufficient to allow the rear portion of the cutting blade to sit in the blade slot recess and the front portion of the cutting blade to extend beyond the front tip of the craft knife handle.

According to an embodiment of the present invention, a blade slot recess is formed in the front of the middle segment of the craft knife handle. In a preferred embodiment, the blade slot recess is a notch, indentation, groove, or similar depression that extends into the middle segment of the craft knife handle and is configured to provide a friction fit with the rear portion of the cutting blade by engaging with the rear edges of the cutting blade. In the preferred embodiment, the blade slot recess begins at the point where the threading begins on the middle segment of the craft knife handle. As the blade slot recess extends into the craft knife handle, the blade slot recess initially has the same height as the rest of the blade slot, but begins to taper down in height from both the top and bottom of the blade slot recess. The taper of the blade slot recess may appear as two ridges or bumps, with one on the top side of the blade slot recess and another on the bottom. The tapering of the blade slot recess enables a tighter fit between the craft knife handle and the cutting blade, as the tapered blade slot recess compensates for various manufacturing tolerances in cutting blades, as well as the craft knife handle. When a cutting blade is inserted into the blade slot in the front segment of the craft knife handle, the rear portion of the cutting blade is eventually pushed into the blade slot recess where the tapering height of the blade slot recess causes the blade slot recess to firmly grip the edges of the cutting blade. By firmly gripping the edges of the cutting blade, the blade slot recess reduces or eliminates blade wiggle or shifting that can result from manufacturing tolerance in the cutting blade, in particular vertical wiggle that is caused by tolerances in the height of the cutting blade.

According to an embodiment of the present invention, the middle segment of the handle body is configured with a collar engagement means that enables the handle body to reversibly engage with the handle collar. In a preferred embodiment, the collar engagement means on the middle segment is formed as a threaded portion that reversibly engages with a corresponding threaded portion on the interior of the handle collar. The threaded portion of the handle body allows the handle collar to be tightened onto the handle body to secure the cutting blade within the blade slot.

According to an embodiment of the present invention, the rear segment of the handle body is formed with at least one flat facet to prevent unwanted rolling of the craft knife handle. In a preferred embodiment, the rear segment is formed with a raised flat portion that extends off of the otherwise generally cylindrical shape of the handle body. In the preferred embodiment, the raised flat portion prevents unwanted rolling of the craft knife handle when the craft knife handle is placed on a surface. Additionally, the rear segment also forms the rear tip of the craft knife handle. The rear tip of the craft knife handle may be configured to receive the safety cap of the craft knife handle, with the safety cap being pushed onto and over the rear tip of the handle body and being secured with a friction fit.

According to an embodiment of the present invention, the handle collar of the craft knife handle may be primarily tubular in shape and is configured to reversibly engage with the handle body of the craft knife handle, as well as being the portion of the craft knife handle by which craft knife handle is generally held while the user is making cuts. In a preferred embodiment, the handle collar is configured as a tube with a handle body engagement means formed on at least a portion of the interior of the handle collar. In preferred embodiment, the handle body engagement means is configured to engage with the collar engagement means on the handle body. The handle body engagement means of the handle collar is preferably formed as a threaded portion on the interior of the handle collar. In the preferred embodiment, the threaded portion of the handle collar is configured to engage with a corresponding threaded portion on the collar engagement means of the handle body. When the handle collar is threaded onto the handle body, the handle collar causes the blade slot of the handle body to tighten against and firmly grip the front and rear faces of the cutting blade so that the cutting blade is held securely within the blade slot in the front segment of the handle body. Conversely, as the handle collar is loosened from the handle body, the cutting blade can be removed or replaced. In the preferred embodiment, the front tip of the handle collar has a slightly smaller diameter than the rest of the interior of the handle collar. The exterior diameter of the handle collar is smallest at the front tip of the handle collar and gradually increases to the full diameter of the handle collar, leaving most of the handle collar to be the larger diameter. The interior diameter of the handle collar begins with a slightly small diameter for a short segment, and then gradually increases to the full interior diameter roughly in parallel with the outside diameter, thereby creating a handle collar that has front tip that has slightly smaller diameter relative to the rest of the handle collar. In the preferred embodiment, the short smaller interior diameter segment of the handle collar is connected to the larger diameter remainder of the handle collar by a sloped segment. By changing diameter via a sloped segment, as opposed to in a stepped fashion, the handle collar of the craft knife handle generates an increased gripping force on the first segment of the handle body, without damaging the handle body. Additionally, the handle collar may be weighted and made from a material such as copper to provide a weighted balance to the craft knife handle. Furthermore, the handle collar may be textured or otherwise configured with an anti-slip grip to allow for a secure grip and precise control of the craft knife handle. One of ordinary skill in the art would appreciate that there are many suitable designs for a handle collar of a craft knife, and embodiments of the present invention are contemplated for use with any such design.

According to an embodiment of the present invention, the blades used in the craft knife handle of the present invention may be constructed from a ceramic material that is capable of withstanding extended use without becoming dull or unusable. Ceramic materials appropriate for such construction include, but are not limited to, Zirconium Oxide. In certain cases, manufacturing costs and other design limitations of blade made from ceramic materials require that the blades be formed without and holes or notches, which can weaken the strength of a ceramic blade. However, the handle collar and handle body of the craft knife handle of the present invention are adapted to securely hold a cutting blade without the need to engage with a hole or notch formed in the cutting blade. One of ordinary skill in the art would appreciate that there are numerous ceramic materials that could be utilized with embodiments of the present invention. Alternatively, embodiments of the present invention may be used with standard craft knife blades.

According to an embodiment of the present invention, the blades used in the craft knife may contain rounded tips to reduce the chance of injury.

According to an embodiment of the present invention, the craft knife handle may further include a safety cap that is configured to reversibly attach to both the front tip and the rear tip of the craft knife handle via friction fit between the safety cap and the craft knife handle. In particular, the safety cap engages with the front tip of the craft knife handle by sliding over handle collar at the front segment of the handle body and engages with the rear tip of the craft knife handle by sliding over the rear segment of the handle body. In a preferred embodiment, the craft knife handle may be formed with at least one flat facet to provide for a no-roll design. When the craft knife handle is not being used, the safety cap can be pushed onto and over the front tip of the craft knife handle, thereby covering the cutting blade to improve safety and prevent wear on the cutting blade. When the craft knife handle is being used, the safety cap can be secured to the rear of the craft knife handle, thereby keeping the safety cap together with the craft knife handle and reducing the chance the safety cap becomes loss or otherwise misplaced from the craft knife handle. One of ordinary skill in the art would appreciate that there are many suitable designs for a safety cap, and embodiments of the present invention are contemplated for to take advantage of any such design.

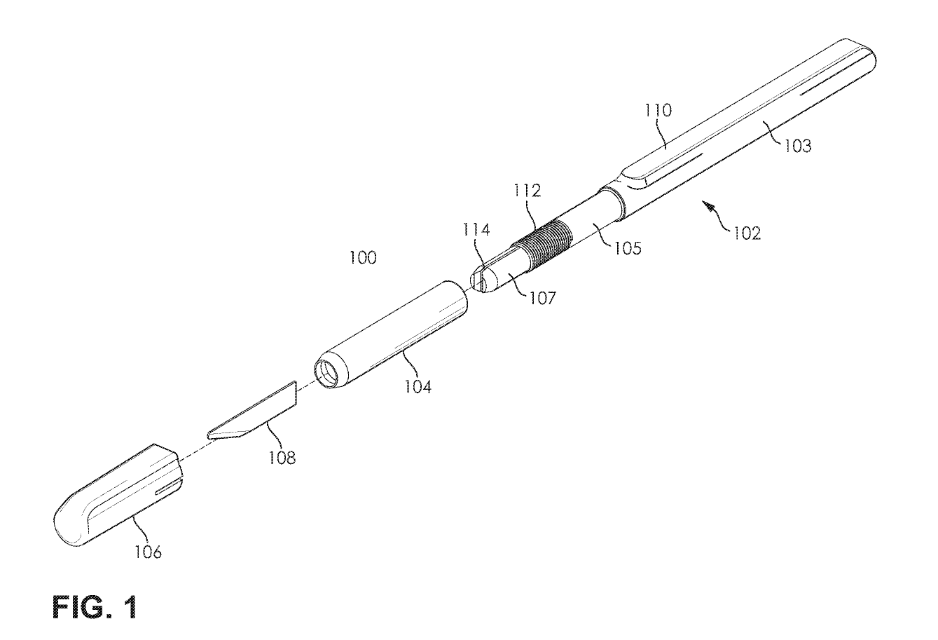

Turning now to FIG. 1, an exploded view of a craft knife handle, in accordance with an embodiment of the present invention. In a preferred embodiment, the craft knife handle 100, primarily comprises a handle body 102, a handle collar 104, a safety cap 106, and a cutting blade 108. The cutting blade 108 is inserted into the blade slot 114 that is formed in the front segment 107 of the handle body 102. As the handle collar 104 is threaded onto the collar engagement means 112 formed on the middle segment 105 of the handle body 102, the handle collar 104 will cause the blade slot 114 to tighten on the cutting blade 108, thereby securing the cutting blade 108 within the craft knife handle 100. In the preferred embodiment, the rear segment 103 of the handle body 102 is formed with at least one flat facet 110 that gives the craft knife handle 100 a no-roll design. Finally, the craft knife handle 100 may include a safety cap 106 that covers the cutting blade 108 when the craft knife handle 100 is not in use.

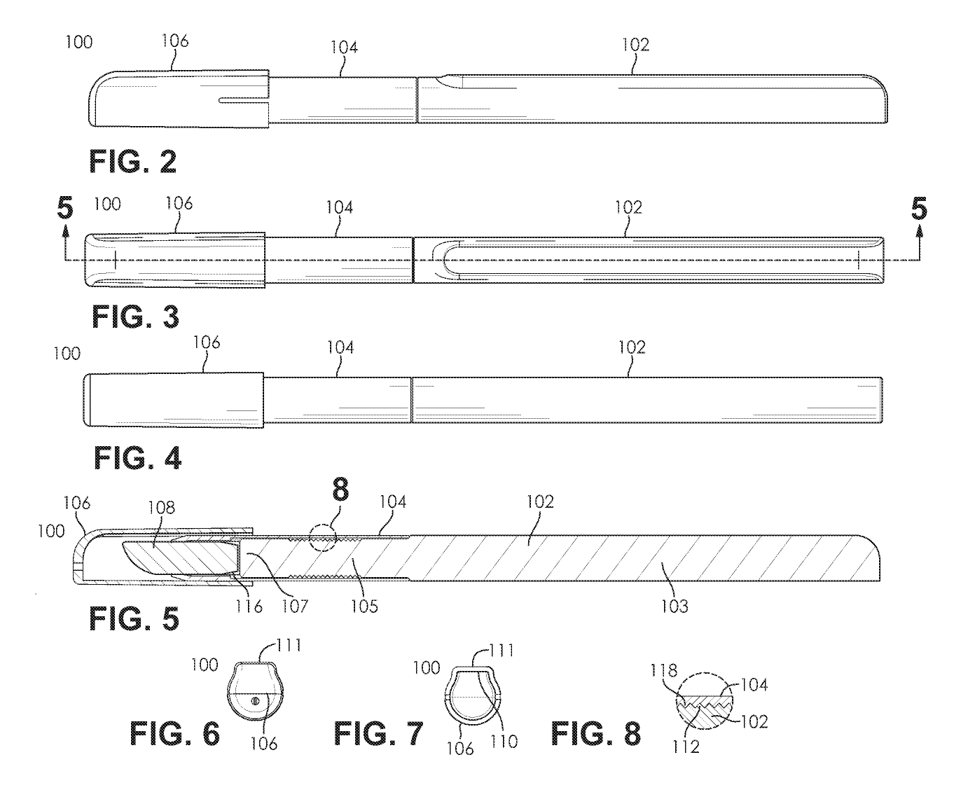

Turning now to FIGS. 2-4, side, top, and bottom views of a craft knife handle in accordance with an embodiment of the present invention. In a preferred embodiment, the craft knife handle 100 primarily comprises a handle body 102, a handle collar 104, and a safety cap 106. The handle collar 104 is configured to reversibly engage with the handle body 102. The safety cap 106 is configured to engage with the front tip of the craft knife handle 100 with a friction fit.

Turning now to FIG. 5, a cross-section of a craft knife handle in accordance with an embodiment of the present invention. In a preferred embodiment, the craft knife handle 100 primarily comprises a handle collar 104 that reversibly engages with a handle body 102. As shown by the detail view in FIG. 8, a threaded collar engagement means 112 formed on the middle segment 105 of the handle body 102 engages with threaded handle body engagement means 118 formed on the interior of the handle collar 104. The safety cap 106 is configured to cover the cutting blade 108 by sliding over the front segment 107 of the handle body 102, with the safety cap 106 being retained on the handle body 102 with a friction fit. The cutting blade 108 is inserted into the blade slot until the rear of the cutting blade 108 is pressed into the blade slot recess 116.

Turning now to FIGS. 6 and 7, front and rear views of a craft knife handle in accordance with an embodiment of the present invention. In a preferred embodiment of the present invention, as shown in FIG. 6, the safety cap 106 is configured to attach to the front tip of the craft knife handle 100 with a friction fit. The safety cap 106 is intended to cover the cutting blade when the craft knife handle 100 is not is use. The safety cap 106 may also be attached to the rear of the craft handle knife 100 so that the safety cap 106 does not become separated from the craft knife handle 100 during use. The safety cap 106 may include at least one flat facet 111 that corresponds to the flat facet 110 of the craft knife handle 100.

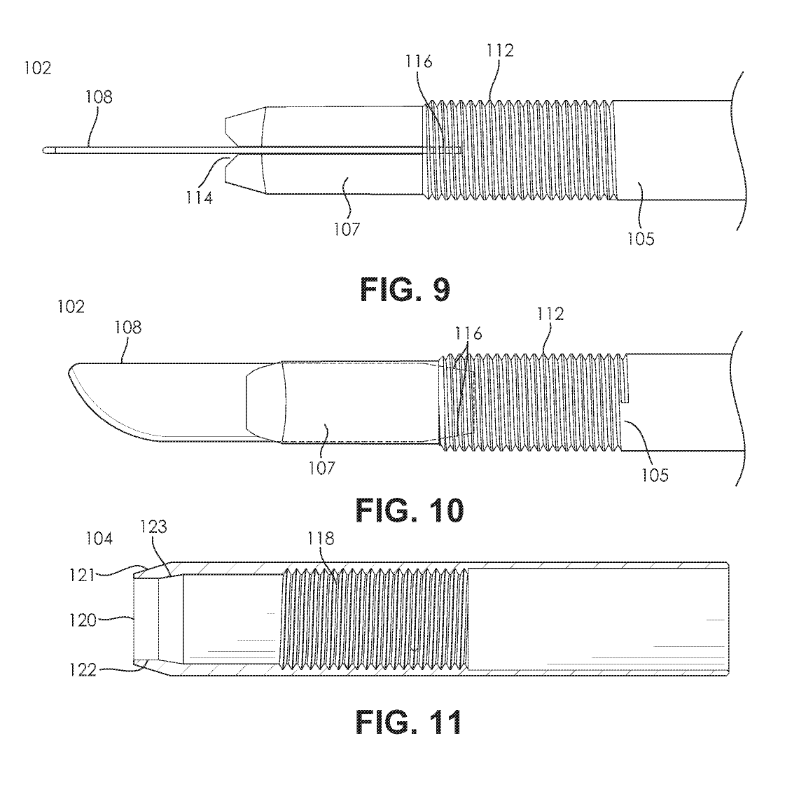

Turning now to FIGS. 9 and 10, top and side views of the blade slot of a craft knife handle in accordance with an embodiment of the present invention. In a preferred embodiment, the blade slot 114 begins as a V-shaped notch at the tip of the front segment 107 of the handle body 102, extends through the entirety of the front segment 107, and terminates at the blade slot recess 116, which is formed as an indentation that extends into the middle segment 105 of the handle body 102 just beneath the collar engagement means 112. In the preferred embodiment, as shown by FIG. 10, the blade slot recess 116 tapers down in height as it extends into the middle segment 105 of the handle body 102. As the cutting blade 108 is inserted into the blade slot 114, the rear edges of the cutting blade 108 will eventually come into contact with the tapered top and bottom walls of the blade slot recess 116. The tapered walls of the blade slot recess 116 reduce or eliminate vertical wiggle of the cutting blade 108 that can result from manufacturing tolerances in the cutting blade 108.

Turning now to FIG. 11, a cross section of a handle collar in accordance with an embodiment of the present invention. In a preferred embodiment, the handle collar 104 is primarily a tubular shaped component, with a threaded handle body engagement means 118 formed on at least portion of the interior of the handle collar 104. In the preferred embodiment, the front tip 120 of the handle collar 104 is slightly smaller in diameter relative to the remainder of the handle collar 104. The exterior diameter of the handle collar 104 is smallest at the front tip 120 of the handle collar and gradually increases to the full diameter with a gradual slope 121. The interior diameter of the handle collar 104 begins with a slightly smaller diameter for a short segment 122, then gradually increases to the full interior diameter over a gradually sloped segment 123 on the interior of the handle collar 104. By changing interior diameter with a gradual slope 123, as opposed to in a stepped fashion, the handle collar 104 provides an increased gripping force on the handle body, without damaging the handle body.

According to an alternate embodiment of the current invention, the craft knife handle comprises of closed loop handle for handling the alternate embodiment with a finger. Specifically, instead of a rod handle body, the handle body here comprises of a single continuous unit that extends into a closed ring. The substitution of a rod handle body with a closed ring body allows for more versatility in the handling of the alternate embodiment. For example, the user can thread a preferred finger through the closed ring, so that the threaded finger can guide the knife across a cutting surface. However, the user can also grasp the current alternate embodiment around the closed loop. Thus, the current alternate embodiment allows for greater versatility in, and consequently stability for, use.

According to variations of the alternate embodiment, the closed ring portion is flexed to yield comfort and enable precise movements for use. In the preferred variation of the alternate embodiment, the closed ring is angled upwards. In greater detail, the closed ring portion is flexed and angled upwards so that a user can insert a finger from the rear opening of the closed loop towards the front. Once the finger is threaded through the loop, the alternate embodiment can be held as if the user were holding a pen. Specifically, the threaded finger can be positioned towards the front face of the handle collar to guide and control the movement of the alternate embodiment, while a thumb is positioned on a side face of the handle collar to offer support. One of ordinary skill in the art would appreciate that there are numerous angles, degrees and direction in which the ring portion.

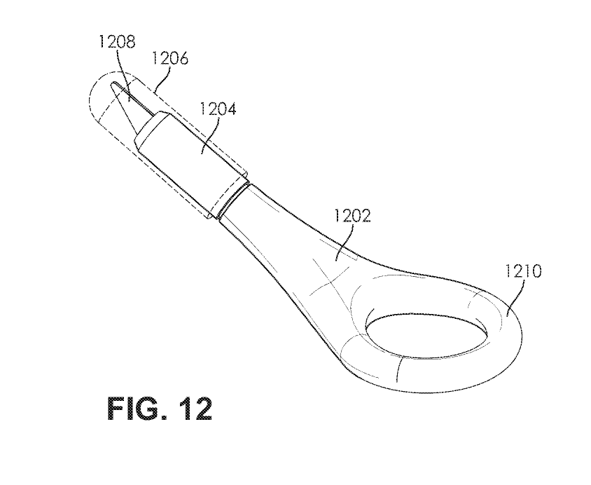

Turning now to FIG. 12, a front view of a precision knife with a ring hook in accordance with an alternate embodiment of the present invention. In this embodiment, the handle collar 1204 is primarily a tubular shaped component, with a threaded handle body engagement means (not shown) formed on at least portion of the interior of the handle collar 1204. A cutting blade 1208 is inserted into the blade slot (not shown) and covered with a safety cap 1206. The handle body 1202 comprises of a ring shaped handle (1210), wherein the ring shaped handle is arched upwards in the preferred embodiment.

It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

The claimed invention is:

1. A ring knife comprising:
a cutting blade, a handle collar, and a handle body,
wherein said handle body comprises of a front segment formed with a blade slot, a middle segment formed with a collar engagement means, and a rear segment formed as a single continuous unit extending into a closed ring,
wherein said cutting blade slot extends through said front segment and terminates as a blade slot recess that is formed as an indentation in said middle segment that tapers down in height as said blade slot recess extends into said middle segment; and
a handle collar formed as a tube with a handle body engagement means on an interior portion of said handle collar.

2. The ring knife of claim 1, wherein a rear end of said closed ring is arched.

3. The ring knife of claim 2, wherein said rear end of said closed arched upwards.

4. The ring knife of claim 1, further comprising a safety cap.

5. The ring knife of claim 4, wherein said safety cap is formed with at least one flat facet, each of which corresponds to one of said flat facets on said rear segment.

6. The ring knife of claim 1, further comprising a cutting blade.

7. The ring knife of claim 1, wherein said blade slot is formed entirely through said front segment and passes through the longitudinal axis of said front segment.

8. The ring knife of claim 1, wherein said collar engagement means is a threaded portion formed on said middle segment.

9. The ring knife of claim 8, wherein said collar engagement means defines a front boundary of said middle segment.

10. The ring knife of claim 9, wherein said blade slot recess begins extending into said middle segment at said front boundary.

11. The ring knife of claim 1, wherein said blade slot begins as a V-shaped notch in a front tip of said front segment.

12. The ring knife of claim 1, wherein said blade slot recess is adapted to abut with one or more rear edges of a cutting blade to prevent vertical movement of said cutting blade within said blade slot.

13. The ring knife of claim 1, wherein a front tip of said interior portion of said handle collar has sloped segment connecting between a first interior diameter segment and a second interior diameter segment that has a larger diameter than said first interior diameter segment.

14. The ring knife of claim 1, wherein handle body engagement means is a threaded portion formed on an interior portion of said handle collar.
